(19) United States
(12) Patent Application Publication
(10) Pub. No.: US 2012/0177553 A1
(43) Pub. Date: Jul. 12, 2012

(54) Injector And Method For Reducing Nox Emissions From Boilers, IC Engines and Combustion Processes

(76) Inventors: Scott H. Lindemann, Oxford, CT (US); Bruce E. Hartel, Shelton, CT (US); John N. Dale, Stratford, CT (US); Jeffrey Michael Broderick, Ridgefield, CT (US); James M. Valentine, Fairfield, CT (US)

(21) Appl. No.: 13/313,683

(22) Filed: Dec. 7, 2011

Related U.S. Application Data
(60) Provisional application No. 61/420,642, filed on Dec. 7, 2010.

(51) Int. Cl. B01D 53/56

(52) U.S. Cl. 423/239.1; 422/168; 422/105; 422/172

(57) ABSTRACT

A system and method of reducing NOx emissions from a lean burn combustion source is provided. The system includes at least one injection lance having a elongated shaft with distal and proximal ends, a metering valve positioned at the distal end, an atomization chamber positioned between the metering valve and the distal end, a storage chamber for containing a reagent fluidly connected to the metering valve, an injection tip positioned at the proximal end for delivering the reagent, and at least one air port for supplying air to the atomization chamber. The injection lance is positioned in the combustion source, and the reagent is supplied from the storage chamber to the injection lance at an inlet pressure. The reagent is then injected into the combustion source via the injection lance, wherein a temperature of the reagent prior to the injection is maintained below a hydrolysis temperature of the reagent.

### CROSS-REFERENCE TO RELATED APPLICATIONS

This application claims the benefit of, under 35 U.S.C. 119(e), U.S. Provisional Patent Application No. 61/420,642, filed Dec. 7, 2010, which application is hereby incorporated by reference herein.

### FIELD OF THE INVENTION

The present invention relates generally to the reduction of oxides of nitrogen (NOx) emissions produced by lean burn combustion sources. In particular, the present invention provides methods and apparatus for injecting a reagent, such as an aqueous urea solution, via an air assisted injection lance such that a temperature of the reagent prior to the injection is maintained below a hydrolysis temperature of the reagent to prevent the reagent from decomposing and depositing on the injector parts. The reagent is injected between an outlet of a second pass and an entrance to a third pass of the combustion source to use the heat of the combustion gases to decompose the urea reagent to ammonia without the need for external heat or power or a separate decomposition reactor or bypass duct. The resulting ammonia is directed across a NOx reducing catalyst where NOx is reduced in the presence of ammonia to elemental nitrogen and water vapor.

### BACKGROUND OF THE INVENTION

Lean burn combustion sources provide improved fuel efficiency by operating with an excess of oxygen over the amount necessary for complete combustion of the fuel. Such combustion sources are said to run “lean” or on a “lean mixture.” Examples of such combustion sources include boilers, furnaces, process heaters, incinerators, internal compression engines and gas turbines firing hydrocarbon based fuels or biomass derived fuels. However, this increase in fuel economy is offset by undesired pollution emissions, specifically in the form of oxides of nitrogen (“NOx”).

The art has found high levels of reduction of nitrogen oxide emissions from boilers and internal combustion engines to generally require the injection of reagents of ammonia based compounds or urea based compounds into the exhaust for reaction with nitrogen oxides across a catalyst in a process know in the art as selective catalytic reduction (SCR). SCR, when used, for example, to reduce NOx emissions from a diesel engine, involves injecting an atomized reagent into an exhaust stream of the engine in relation to one or more selected engine operational parameters, such as exhaust gas temperature, engine rpm or engine load, as measured by engine fuel flow, turbo boost pressure or exhaust NOx mass flow. The reagent/exhaust gas mixture is passed through a reactor containing a catalyst, such as, for example, activated carbon, or metals, such as platinum, vanadium or tungsten, or an iron or copper based zeolite, which are capable of reducing the NOx concentration in the presence of the reagent. An SCR system of this type is disclosed in U.S. Pat. No. 5,976,475 to Peter-Hoblyn et al.

Ammonia based reagent, especially gaseous ammonia, is advantageous in that it does not require long residence times for evaporation of water and conversion to a reactive ammonia species. It can, therefore, be closely coupled with the SCR catalyst, with the injectors located in low temperature exhaust gas zones immediately upstream from the catalyst. On the other hand, gaseous ammonia presents storage and handling concerns due to its hazardous nature. Many small industrial and commercial institutions, such as hospitals, schools and food processors, have restrictions on the presence of ammonia due to safety and health concerns.

An aqueous urea solution is known to be an effective reagent in SCR systems for lean burn combustion sources. However, use of the aqueous urea solution involves many disadvantages. Urea is highly corrosive and attacks mechanical components of the SCR systems, such as the injectors used to inject the urea mixture into the exhaust gas stream. Urea also tends to solidify upon prolonged exposure to high temperatures, such as encountered in diesel exhaust systems. Solidified urea will accumulate in the narrow passageways and exit orifice openings typically found in injectors. Solidified urea may foul moving parts of the injector and clog any openings, rendering the injector unusable.

In addition, if the urea mixture is not finely atomized, urea deposits will form in the catalytic reactor, inhibiting the action of the catalyst and thereby reducing the SCR system effectiveness. High injection pressures are one way of minimizing the problem of insufficient atomization of the urea mixture. However, high injection pressures often result in over-penetration of the injector spray plume into the exhaust stream, causing the plume to impinge on the inner surface of the exhaust pipe opposite the injector. Over-penetration leads to inefficient use of the urea mixture and requires that much more be used.

Especially in small institutional and commercial fire tube boilers, the industry has been looking for a way to utilize safe urea reagents for high levels of catalytic NOx reduction alone or in conjunction with selective non catalytic reduction (“SNCR”), low NOx burners or flue gas recirculation. Known urea based systems used in selective non catalytic reduction systems on large boilers typically require large quantities of water to be injected with the urea for penetration and distribution into the furnace at temperatures of 1700-2200 F and to prevent precipitation of urea crystals in lines, pumps and injectors. In addition, poor atomization of the liquid urea reagent can cause reagent to deposit on boiler, exhaust duct or downstream SCR catalyst surfaces causing fouling.

There have been several attempts to overcome the disadvantages of known urea based NOx reduction systems. For example, U.S. Pat. No. 4,978,514 to Hoffmann et al. describes the use of a 10% solution of urea for SNCR and to generate ammonia for a downstream catalyst. Hoffmann et al. propose introducing a nitrogenous treatment agent into an effluent at temperatures of 1200 to 2100 F and employing an enhancer, such as sugar or molasses, when the temperature is below 1600 F.

U.S. Pat. No. 5,286,467 to Sun et al. describes the injection of a reagent into an effluent at 1500 F-2100 F to reduce a first increment of NOx through SNCR and to create ammonia, and then introducing an additional source of ammonia to an exhaust, and contacting the exhaust with a catalyst for a combined SNCR/SCR process. Sun et al. also describes the use of a dilute 10% urea solution. U.S. Pat. No. 5,139,754 to Luftglass et al. describes a similar combination of SNCR and SCR with injection at a temperature of 1200 F-2100 F and a 10% aqueous solution of urea. Arand, in U.S. Pat. No. 4,208,386 teaches the injection of urea into effluents at a temperature of 1300 F to 2000 F for reducing NOx through SNCR, while Lyon, in U.S. Pat. No. 3,900,554, teaches the injection of ammonia into combustion effluent at 1300 F to 2000 F.

Groff and Gullett, in a publication entitled “Industrial Boiler Retrofit for NOx Control: Combined Selective Noncatalytic Reduction and Selective Catalytic Reduction,” describe the application to a small two million Btu/hour fire tube boiler. An injection of a dilute solution of urea into an end of a first pass combustion tube at a temperature of 900 C (1652 F) is used to obtain a first increment of NOx reduction and to generate ammonia. The generated ammonia is then fed to a downstream catalyst retrofitted between second and third passes of the boiler. Three gallons per hour quantity of a reagent for this small boiler suggests that a very dilute solution of urea is required to overcome the high temperatures in the first pass combustion zone. Other fire tube boilers with temperatures in excess of 2100 F at the end of the first pass would actually convert urea into NOx if injected into the combustion tube, as proposed by Groff and Gullett.

Given that SNCR processes have poor reagent utilization relative to SCR processes, it would be desirable to maximize the efficiency of the SCR process without the complexity of controlling two separate processes, as in the combined SNCR/SCR processes. It would also be desirable to minimize the quantity of water injected into the boiler, and to use standard industrial concentrations of 32.5% urea in solution.

Several urea systems, therefore, use large and costly evaporators and conversion reactors or exhaust bypass ducts to convert urea to ammonia on site prior to injection into the exhaust duct for reaction across a catalyst. This requires large quantities of heat or power to convert urea to ammonia and can result in large quantities of ammonia gas still being present on site. For example, U.S. Pat. No. 7,090,810 to Sun et al. describes a process for a large scale combustor, wherein urea is introduced into a side stream of gases at a temperature for gasification for 1-10 seconds, and the side stream is then introduced into a primary stream and passed through a catalyst for NOx reduction.

U.S. Pat. No. 6,436,359 to Spencer et al. describes the hydrolysis of urea in a closed reactor to produce gaseous ammonia and an elaborate scheme for controlling the hydrolysis. These techniques are generally designed for large scale combustion sources, such as utility coal fired boilers or large industrial boilers. The application of these techniques to small institutional commercial or industrial boilers presents cost, space and operating issues. It would be desirable, therefore, to have a system for easy in situ generation of ammonia from urea without the need for separate reactors, bypass ducts, heating elements, dampers or complex control schemes.

U.S. Pat. No. 5,968,464 and U.S. Pat. No. 6,203,770 to Peter-Hoblyn et al. describe the use of a pyrolysis chamber located in an exhaust of a diesel engine, into which a urea solution is sprayed and converted to ammonia gas. However, the structure proposed by Peter-Hoblyn is likely prone to plugging by urea decomposition products. U.S. Pat. No. 6,361,754 to Peter Hoblyn et al. describes the injection of urea into a heated vessel to produce ammonia, and the controlled release of ammonia from the vessel into an exhaust across a catalyst. Although Peter Hoblyn et al. describe the use of a return flow injector, the applications are generally directed at a traditional diesel engine, and not specifically at a fire tube boiler. It is not clear how the methods and apparatuses of Peter Hoblyn et al. would be applied to a low temperature exhaust of a fire tube boiler for effective urea to ammonia conversion without the use of external heating of the pyrolysis chamber.

Therefore, it would be advantageous to provide a method of utilizing safe urea reagent by converting a urea solution into fine droplets for quick conversion to ammonia at a point of injection into a combustion zone or steam generation zone of a boiler using the heat of the combustion gases to decompose the urea to ammonia without forming deposits on boiler surfaces, duct work, or catalyst surfaces. This would be especially advantageous on small industrial or commercial fire tube boilers, where injection of urea into the low temperature exhaust at the outlet of the boiler is problematic due to the slow decomposition of urea to active ammonia species at the low temperatures.

### SUMMARY OF THE INVENTION

It is an objective of the present invention to provide a system and method for reducing NOx emissions that maximize the efficiency of the SCR process without the complexity of controlling two separate processes, as in the combined SNCR/SCR processes.

It is also an objective of the present invention to provide a system and method for reducing NOx emissions that minimize the quantity of water injected into the boiler and that are capable of utilizing standard industrial concentrations of urea in solution.

It is further an objective of the present invention to provide a system and method for reducing NOx emissions that are capable of utilizing safe urea reagent by atomizing a urea solution for fast conversion to ammonia at a point of injection into a combustion zone or steam generation zone of a boiler.

It is yet further an objective of the present invention to provide a system and method for reducing NOx emissions that utilize the heat of combustion gases to decompose urea to ammonia without forming deposits on boiler surfaces, duct work, or catalyst surfaces.

These and other objectives are achieved by providing a method of reducing NOx emissions from a lean burn combustion source, including the steps of positioning at least one injection lance having a distal end a proximal end in the combustion source, the at least one injection lance comprising an elongated shaft, a metering valve secured to the distal end, an atomization chamber positioned between the metering valve and the elongated shaft, and an injector tip removably secured to the proximal end, supplying a reagent from a storage chamber to the at least one injection lance at a reagent inlet pressure, injecting the reagent into the combustion source via the at least one injection lance, and providing air to the atomization chamber of the at least one injection lance at an air inlet pressure, wherein a temperature of the reagent prior to the injection is maintained below a hydrolysis temperature of the reagent and the reagent decomposes in the combustion source to reduce NOx across a catalyst.

In some advantageous embodiments, the at least one injection lance is positioned in a cavity formed between an outlet of a second pass and an entrance to a third pass of the combustion source.

In certain embodiments, the reagent comprises a urea solution. In some of these embodiments, the urea solution comprises a solution of about 25% to about 40% of urea in water. In certain of these embodiments, the urea solution comprises a solution of about 32.5% of urea in water.

In some embodiments, a combustion gas temperature at the injection point is between about 400 F and about 1100 F. In certain of these embodiments, a combustion gas temperature at the injection point is between about 400 F and about 750 F.

In certain embodiments, a quantity of the injected reagent is controlled via the metering valve in response to at least one of a combustor load, a fuel flow, a temperature and a NOx signal.

In some advantageous embodiments, the valve is a pulse width modulated solenoid valve.

In certain embodiments, the method further includes the step of recirculating at least a portion of the reagent from the at least one injector lance to the storage chamber or to an inlet of a recirculation pump.

In some embodiments, the reagent inlet pressure is between about 40 psi and about 120 psi.

In other advantageous embodiments, the reagent is injected at a rate between about 0.04 gallon per hour and about 10 gallons per hour.

In some of embodiments, air is provided at a flow rate between about 2 standard cubic feet per minute and about 20 standard cubic feet per minute. In other of these embodiments, air is provided to the at least one injection lance at an air inlet pressure between about 5 psi and about 40 psi.

In some embodiments, the method also includes the step of adjusting the air inlet pressure until the reagent is injected with droplet sizes between about 10 microns and about 50 microns.

In certain embodiments, the method further includes the step of actuating the at least one injection lance on and off at a predetermined frequency. In certain of these embodiments, the method further includes the step of modulating a pulse width of the metering valve to control injection rate of the reagent.

Other objectives are achieved by provision of a method of reducing NOx emissions from a lean burn combustion source is also provided, including the steps of positioning at least one injector in a cavity formed between an outlet of a second pass and an entrance to a third pass of said combustion source, providing a reagent from a storage chamber to the at least one injector, injecting the reagent into a combustion gas via the at least one injector, and recirculating at least a portion of the reagent from the at least one injector to the storage chamber.

Further provided is a system for reducing NOx emissions from a lean burn combustion source is further provided, including at least one injection lance having a hollow elongated shaft with a distal end and a proximal end, a metering valve positioned at the distal end of the elongated shaft, an atomization chamber positioned between the metering valve and the distal end of the shaft, a storage chamber for containing a reagent fluidly connected to the metering valve, an injection tip positioned at the proximal end of the shaft for delivering the atomized reagent, and at least one air port for supplying air from an air source to the atomization chamber and injecting into combustion gases upstream of a catalyst.

In some embodiments, the reagent comprises a urea solution. In certain of these embodiments, the urea solution comprises a solution of about 25% to about 50% of urea in water. In certain of these embodiments, the urea solution comprises a solution of about 32.5% of urea in water.

In certain advantageous embodiments, the system also includes a reagent return flow to and from the metering valve. In other advantageous embodiments, the reagent is supplied to the metering valve without a return flow.

In some embodiments, the system further includes a controller coupled to the metering valve for controlling a rate of reagent injection based on at least one of a combustor load, a fuel flow, a temperature and a NOx signal.

In certain embodiments, the valve receives the reagent from the storage chamber at a pressure rate of about 40 psi to about 120 psi.

In some embodiments, the system also includes a plurality of injection tips removably securable to the proximal end of the shaft for providing a plurality of reagent spray patterns.

In certain advantageous embodiments, the atomization chamber receives air from the at least one air port at a pressure rate of about 5 psi to about 40 psi. In further advantageous embodiments, the atomization chamber receives air from the at least one air port at a flow rate of 2 standard cubic feet per minute to 20 standard cubic feet per minute.

A system for reducing NOx emissions from a lean burn combustion source having at least three passes is also provided, including a cavity formed between an outlet of a second pass and an entrance to a third pass of the combustion source, and at least one injection lance positioned in the cavity. The injection lance includes a hollow elongated shaft with a distal end and a proximal end, a metering valve positioned at the distal end of the elongated shaft, an atomization chamber positioned between the metering valve and the distal end of the shaft, a storage chamber for containing a reagent fluidly connected to the metering valve, an injection tip positioned at the proximal end of the shaft for delivering the atomized reagent, and at least one air port for supplying air from an air source to the atomization chamber.

Other objects of the invention and its particular features and advantages will become more apparent from consideration of the following drawings and accompanying detailed description.

### BRIEF DESCRIPTION OF THE DRAWINGS

The present invention will hereinafter be described in conjunction with the appended drawing figures, wherein like numbers denote like elements, and:

FIG. 1 shows a longitudinal cross-sectional view of an exemplary embodiment of a system for reducing NOx emissions from a lean burn combustion source according to the present invention;

FIG. 2 shows a longitudinal cross-sectional view of another exemplary embodiment of the system of FIG. 1; and

FIG. 3 shows a schematic diagram of a four pass combustion source with the system of FIG. 1.

### DETAILED DESCRIPTION OF THE INVENTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an exemplary embodiment of the invention. It should be understood that various changes may be made in the function and arrangement of elements without departing from the spirit and scope of the invention as set forth in the appended claims.

The present invention is directed to the reduction of nitrogen oxide emissions produced by lean burn engines including boilers, combustors, compression engines and gas turbines firing hydrocarbon based fuels or biomass fuels alone, or in combination. In particular the present invention provides a method and apparatus for injecting urea solutions into the heat extraction zone of a small combustion source, such as a fire tube boiler, such that the urea solution is subjected to temperature and residence time to decompose the urea to ammonia without the need for external heat or power, or a separate decomposition reactor or bypass duct. The ammonia is then transported with the combustion gases across a catalyst located in the exhaust outlet of the boiler, where NOx is effectively reduced to elemental nitrogen and water vapor.

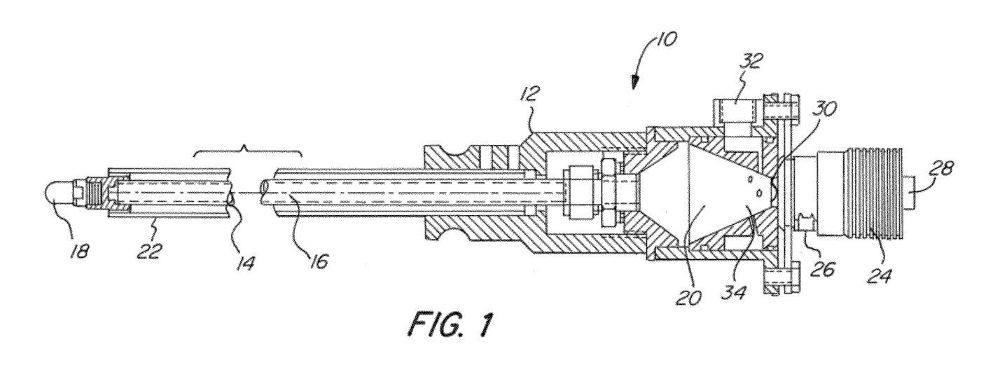

An exemplary embodiment of the novel system for reducing NOx emissions from a lean burn combustion source is shown in FIG. 1. The system 10 includes an air assisted injection lance 12 that functions to atomize, cool and transport the reagent into the combustion source. It should be noted that the system of the present invention may utilize more than one injection lance to provide for a more effective reduction of the NOx emissions.

In an advantageous embodiment, the reagent used with the system and method of the present invention is a urea solution consisting of about 25% to about 50% of urea in water, and preferably about 32.5% urea in water. Such urea solutions are widely available as diesel exhaust fluid. It should be noted, however, that other suitable reagents, such as aqueous ammonia solutions or hydrocarbons, can be used as well with the invention.

The injection lance 12 includes an elongated shaft 14 having a distal end and a proximal end. The proximal end of the shaft 14 has an injector tip 18 removably secured thereto for injecting the reagent. The tip 18 is fitted with a slotted or round outlet orifice to provide a desired spray pattern and direction. The system may include a plurality of injector tips removably attachable to the injection lance 12 for providing a plurality of specific and desirable reagent spray patterns.

The distal end of the elongated shaft 14 terminates in an atomizing chamber 20 for receiving and atomizing the reagent. The shaft has an inner lumen 16 fluidly connected to the injector tip 18 and the atomization chamber 20. The elongated shaft 14 is preferably encapsulated in a protective shield 22 made with any suitable heat resistant material for protecting the injection lance 12 from damages caused by high temperatures in the combustion engine. A length of the elongated shaft 14 may vary depending on a particular application.

The system 10 of the present invention further includes a metering valve 24 positioned distally of the atomization chamber 20. Any suitable type of a metering valve may be used in accordance with the present invention. In some advantageous embodiments, a pulse width modulated solenoid metering valve is used. The metering valve 24 is fitted axially on the distal end of the injection lance 12 and is fluidly connected with the atomization chamber 20. The metering valve 24 is used to precisely control the rate of urea solution injected into the atomization chamber 20 based on a signal from a controller (not shown). The quantity of the injected reagent is controlled by the controller in response to at least one predetermined parameter. In some advantageous embodiments, the controller sends a signal to the metering valve 24 to adjust the pulse width (% on time) in response to at least one of load, stack flow, steam output, exhaust temperature, NOx emission measurement or fuel flow, among other indicators.

In some advantageous embodiments, a rate of injection may be adjusted by injecting the reagent from the injection lance 12 in a pulsed fashion. In these embodiments, the injection lance is actuated on and off at a predetermined frequency, depending on a particular application and the pulse width of the metering valve is varied depending upon a particular application. The frequency of the injection lance actuation and/or the pulse width of the metering valve may be controlled by the controller in response to at least one predetermined parameter. In additional advantageous embodiments, a diameter of the opening of the injection tip 18 may be varied and/or the size/shape/configuration of the orifice of the valve outlet 30 of the metering valve may be varied to adjust the injection rates. Furthermore, the pressure at which the regent is supplied to the injection lance 12 may be adjusted to control the rate of injection.

The metering valve 24 is coupled to a reagent inlet 26 connected to a storage chamber (not shown), which contains the reagent. In the exemplary embodiment shown in FIG. 1, the metering valve 24 is also coupled to a reagent outlet 28 connected to the storage chamber. The urea solution is fed by a pump from the storage chamber into the reagent inlet 26 of the metering valve 24 and then is returned from the metering valve 24 to the storage chamber via the reagent outlet 28. This way, the urea solution is recirculated from the injection lance 12 to the storage chamber, which facilitates cooling of the reagent and prevents reagent from depositing on or in the injection lance components and/or in the metering valve.

In certain advantageous embodiments, the metering valve 24 further includes a whirl plate positioned at a valve outlet 30 for producing a cone shaped spray of the reagent, which is then discharged into the atomization chamber 20. In the exemplary embodiment shown in FIG. 1, the atomization chamber 20 has a conical shape, although other shapes may be utilized in accordance with the present invention.

A variable speed pump (not shown) may be used to supply the reagent to the metering valve 24 at an inlet pressure. In one advantageous embodiment, the reagent is supplied to the metering valve 24 at a pressure of about 40 psi to about 120 psi. A pressure sensor may be positioned in the reagent feed line to provide a signal to the controller to adjust the speed of the pump and to maintain the desired pressure to the metering valve 24.

The injection lance 12 further includes an air inlet 32 fluidly connected to the atomization chamber 20 via a plurality of air ports 34. In an advantageous embodiment, the air ports 34 are staggered around a distal portion of the atomization chamber 20 adjacent the metering valve 24. The air ports 34 introduce atomizing air into the liquid reagent spray from the metering valve to mix, atomize, cool and transport the urea reagent to the outlet end of the injection lance 12.

In some advantageous embodiments, the air is introduced into the atomization chamber 20 in a plane perpendicular to a longitudinal axis of the atomization chamber 20 to achieve better atomization of the reagent. In additional advantageous embodiments, the air is supplied to the atomization chamber 20 via the air ports 34. The air and the reagent mix in the atomization chamber 20 and enter the inner lumen 16 of the elongated shaft 14. The low pressure air then transports the reagent through the injector lance 12 and out the injection tip 18. In some advantageous embodiments, the reagent injection rates are between about 0.04 gallons per hour to about 10 gallons per hour, and preferably between about 0.15 gallon per hour to about 5 gallons per hour. The reagent injection rates depend on the quantity of NOx to be reduced and the number of injection lances used.

In addition to atomizing the liquid reagent and cooling the injection lance 12, air is also utilized to purge the lance of residual urea during a shut down. In some advantageous embodiments, the air is provided to the atomization chamber 20 at a pressure of about one (1) psi to about fifty (50) psi, and preferably between about five (5) psi to about forty (40) psi. In additional advantageous embodiment, the air provided at a flow rate of about two (2) standard cubic feet per minute to about twenty (20) standard cubic feet per minute. The airflow rates are determined based on a quantity of the reagent being injected into the metering valve and can be adjusted to match adjustments in the reagent feed rate as operating conditions change. Alternatively, the airflow can be set at a constant flow rate and used for cooling the injector lance even when the reagent is not being injected, such as during start-up or shut down. Additionally, a slipstream of low-pressure combustion air from a wind box or steam from the boiler can be used to assist atomization and transport of the reagent through the injection lance 12.

The air flow through the injection lance 12 and the location of the metering valve 20 remote from a direct contact with high heat of the combustion zone or boiler surfaces are utilized to maintain a temperature in the metering valve 24 below a hydrolysis temperature for urea. This prevents the precipitation of solids from urea decomposition on the metering valve 24 components and the atomization chamber 20. Atomizing, cooling and transport air is also introduced into the chamber in a perpendicular direction to impart shear on the liquid reagent stream. This produces atomization of the reagent and cooling of the metering valve and lance without the need for the return flow of reagent to storage.

In accordance with the present invention, the need for return flow of liquid reagent through the metering valve 24 for cooling and prevention of precipitation of solid urea is eliminated or substantially reduced. Typical high return flow rates required for cooling and preventing urea deposits from forming in the valve in the prior art systems are not required with the novel air assisted injection lance of the present invention. Lower return flow rates have the benefit of allowing smaller pumps, smaller lines and less power consumption for pumping of the reagent.

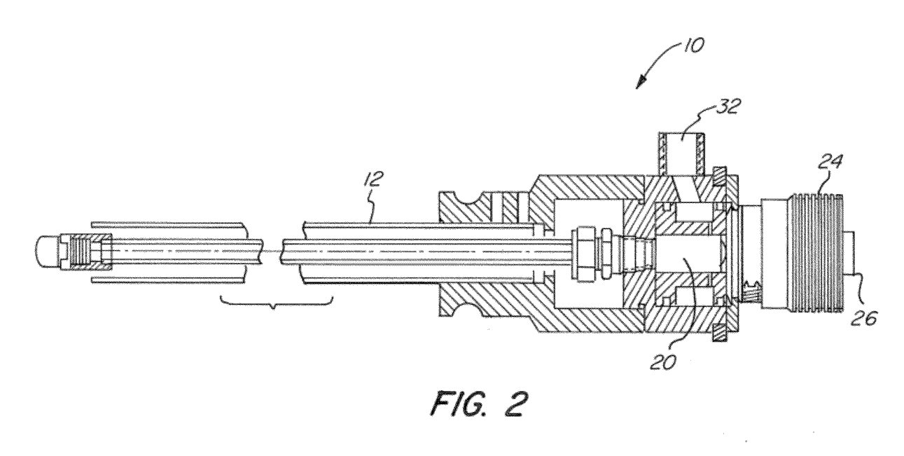

FIG. 2 illustrates another advantageous embodiment of the present invention, wherein the return flow of the reagent from the metering valve is eliminated. In this embodiment, the metering valve 24 is secured directly to the atomization chamber 20 without a whirl plate, and the urea reagent is supplied to the metering valve 24 via the reagent inlet 26 without the return flow through the reagent outlet. This design produces a pin jet discharge of the urea reagent from the metering valve 24, and therefore the atomization chamber 20 is preferably cylindrical rather than conical.

In other advantageous embodiments, the metering valve 24 is mounted on an axis perpendicular to the longitudinal axis of the injector lance 12, and the air is introduced into the atomization chamber 20 in an axial direction at the distal end of the lance 12. In this arrangement, a spray plate may be mounted in the atomization chamber 20 where the air and the reagent meet to allow a pulsed injection of the reagent from the metering valve 24 to the atomization chamber 20. The reagent is mechanically atomized by an impact against the spray plate, with the air used as a mixing, transport and cooling medium to convey the atomized reagent into the combustion zone or exhaust gas flow for NOx reduction across a catalyst. A return flow of the reagent through the metering valve may be utilized in this arrangement, but is not required. A whirl plate may be optionally affixed to the outlet of the metering valve 24 to provide some additional atomization.

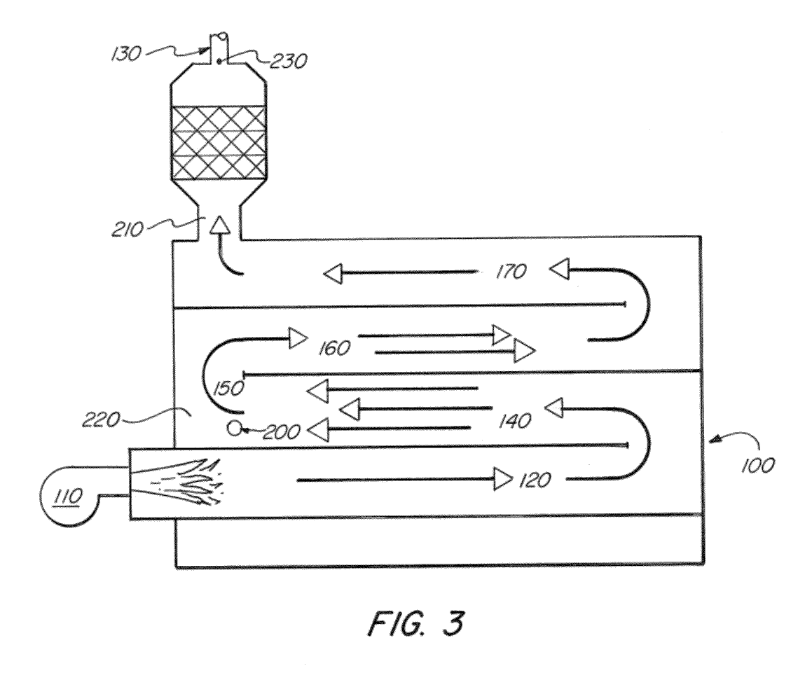

FIG. 3 illustrates a schematic layout of a four pass combustion source, such as a fire tube boiler, with the system for reducing NOx emissions of the present invention in operation. The fire tube boiler 100 is fired by a burner 110 positioned in a center combustion chamber (first pass) 120. As a result, NOx emissions are produced and measured at a boiler exhaust 130. Combustion gases exit the combustion chamber 120 and flow through a bank of fire tubes 140 referred to as the second pass, which are surrounded by water. The heat is extracted from the combustion gases at the second pass 140 and into the water surrounding the tubes. The combustion gases then exit the second pass 140 at a temperature of about 400 F to about 900 F, depending on a boiler load, and pass into a chamber 150. From the chamber 150, the gases flow into a third pass of the fire tubes 160, where additional heat is extracted. The combustion gases exit the third pass 160 and make a final pass back through a fourth pass of tubes 170, where more heat is extracted. Then, the gases exit the top of the boiler through an exhaust duct 210 and enter an SCR catalytic reactor 180 containing multiple layers of catalyst 190 effective for NOx reduction in the presence of ammonia gas at temperatures of about 300 F to about 800 F.

Computational fluid dynamic modeling was used to determine that the optimum location for injection, mixing, thermal decomposition and residence time of the urea reagent is in a cavity 220 following the second pass 140 prior to the entry to the third pass 160. As illustrated in FIG. 3, the air assisted injector lance 200 of the present invention, as described in FIGS. 1 and 2, is installed into a port on the boiler wall at the cavity 220 between the second and third passes. Although only one injector lance 200 is shown in FIG. 3, in many cases, two lances are preferred in order to provide a more balanced distribution of reagent, and in some cases, even more than two lances are desirable. In some advantageous embodiments, the injection lances 200 are installed in the lower section of the boiler cavity and penetrate the furnace wall by approximately three inches to avoid blow back of urea spray and potential deposits on the furnace wall.

In operation, a urea solution is pumped from the storage chamber to the injections lances at a pressure of about 80 psi and at an injection rate of about 0.1-0.2 gallons per hour per injector at full load. The urea solution is injected through the metering valve and into the atomization chamber of the injection lance, where low pressure air, preferably at 10 psi, is separately introduced into the atomization chamber via the air inlet. The air atomizes the urea solution into droplets, which then enter the inner lumen of the injection lance and are transported to a slotted outlet tip of the lance to produce a vertical flat fan spray of atomized urea. The size of the atomized droplet of the urea solution at the injection tip is preferably under 100 microns, and more preferably between about 10 microns to about 50 microns.

The controller adjusts the rate of urea injection as a function of boiler fuel flow by varying the pulse width (on time) of the metering valve. A low temperature vanadium based catalyst 190 is installed in the reactor box 180 at the outlet of the boiler after the fourth pass 170, where the exhaust temperature is about 300 F to about 600 F. NOx emissions are monitored by an electrochemical instrument with a sensor 230 positioned in the exhaust duct 130. NOx is reduced by up to 90% and un-reacted ammonia slip at the outlet of the catalyst is less than 10 ppm, and preferably less than 5 ppm, when corrected to 15% excess oxygen in the flue gas. After several hundred hours of operation with the injection system operating, the boiler is opened and no urea deposits are found in the boiler cavity or on the boiler tubes.

In an exemplary embodiment shown in FIG. 3, the urea injection lances 200 without the return flow feature are mounted in the boiler between the second and third boiler steam generation pass such that the urea reagent can be injected into combustion gases in a temperature range of about 400 F to about 1100 F and provided with sufficient time to allow urea to decompose to ammonia before reaching the SCR catalyst located in the exhaust stack of the boiler. SCR catalysts are commonly of the low temperature design and are generally effective in the range of about 300 F to about 800 F.

However, in other advantageous embodiments, a return flow injector may be used alone without the air assisted injection lance, with examples of such arrangements being shown in U.S. Pat. No. 7,467,740 and U.S. Pat. No. 5,976,475, both of which are incorporated by reference herein. In these embodiments, the injector is mounted directly to the boiler wall between the second and third pass and the return flow of the reagent is used to cool the injector. In additional advantageous embodiments, the return flow injector may be used together with the air assisted injection lance for achieving a finer droplet size and enhancing the reagent distribution into the combustion gases.

The system and method of the present invention may be applied to other combustion systems, including water tube boilers, process combustors, gas turbine exhausts, and internal combustion engine exhausts. In an advantageous embodiment, the system described above is used with combustion systems that operate with an excess of oxygen and have access for injection of urea at a temperature of about 400 F to about 900 F.

Although the invention has been described in connection with various illustrated embodiments, numerous modifications and adaptations may be made thereto without departing from the spirit and scope of the invention as set forth in the claims.

What is claimed is:

1. A method of reducing NOx emissions from a lean burn combustion source, comprising the steps of:
positioning at least one injection lance having a distal end a proximal end in the combustion source, the at least one injection lance comprising an elongated shaft, a metering valve secured to the distal end, an atomization chamber positioned between the metering valve and the elongated shaft, and an injector tip removably secured to the proximal end;
supplying a reagent from a storage chamber to the at least one injection lance at a reagent inlet pressure;
injecting the reagent into the combustion source via the at least one injection lance; and
providing air to said atomization chamber of the at least one injection lance at an air inlet pressure;
wherein a temperature of the reagent prior to the injection is maintained below a hydrolysis temperature of the reagent and the reagent decomposes in the combustion source to reduce NOx across a catalyst.

2. The method of claim 1, wherein the at least one injection lance is positioned in a cavity formed between an outlet of a second pass and an entrance to a third pass of the combustion source.

3. The method of claim 1, wherein the reagent comprises a urea solution.

4. The method of claim 3, wherein the urea solution comprises a solution of about 25% to about 50% of urea in water.

5. The method of claim 4, wherein the urea solution comprises a solution of about 32.5% of urea in water.

6. The method of claim 1, wherein a combustion gas temperature at the injection point is between about 400 F and about 1100 F.

7. The method of claim 6, wherein a combustion gas temperature at the injection point is between about 400 F and about 750 F

8. The method of claim 1, wherein a quantity of the injected reagent is controlled via the metering valve in response to at least one of a combustor load, a fuel flow, a temperature and a NOx signal.

9. The method of claim 1, wherein the valve is a pulse width modulated solenoid valve.

10. The method of claim 1, further comprising the step of recirculating at least a portion of the reagent from the at least one injector lance to the storage chamber or to an inlet of a recirculation pump.

11. The method of claim 1, wherein the reagent inlet pressure is between about 40 psi and about 120 psi.

12. The method of claim 1, wherein the reagent is injected at a rate between about 0.04 gallon per hour and about 10 gallons per hour.

13. The method of claim 1, wherein air is provided at a flow rate between about 2 standard cubic feet per minute and about 20 standard cubic feet per minute.

14. The method of claim 1, wherein air is provided to the at least one injection lance at an air pressure between about 5 psi and about 40 psi.

15. The method of claim 1, further comprising the step of adjusting the air inlet pressure until the reagent is injected with droplet sizes between about 10 microns and about 50 microns.

16. The method of claim 1, further comprising the step of actuating the at least one injection lance on and off at a predetermined frequency.

17. The method of claim 16, further comprising the step of modulating a pulse width of the metering valve to control injection rate of the reagent.

18. A method of reducing NOx emissions from a lean burn combustion source, comprising the steps of:
positioning at least one injector in a cavity formed between an outlet of a second pass and an entrance to a third pass of said combustion source;
providing a reagent from a storage chamber to the at least one injector;
injecting the reagent into a combustion gas via the at least one injector; and
recirculating at least a portion of the reagent from the at least one injector to the storage chamber.

19. A system for reducing NOx emissions from a lean burn combustion source equipped with a catalyst, comprising:
at least one injection lance having a hollow elongated shaft with a distal end and a proximal end;
a metering valve positioned at the distal end of the elongated shaft;
an atomization chamber positioned between the metering valve and the distal end of the shaft;
a storage chamber for containing a reagent fluidly connected to the metering valve;
an injection tip positioned at the proximal end of the shaft for delivering the atomized reagent; and
at least one air port for supplying air from an air source to the atomization chamber and injecting into combustion gases upstream of the catalyst.

20. The system of claim 19, wherein the reagent comprises a urea solution.

21. The system of claim 20, wherein the urea solution comprises a solution of about 25% to about 50% of urea in water.

22. The system of claim 21, wherein the urea solution comprises a solution of about 32.5% of urea in water

23. The system of claim 19, further comprising a reagent return flow to and from the metering valve.

24. The system of claim 19, wherein the reagent is supplied to the metering valve without a return flow.

25. The system of claim 19, further comprising a controller coupled to the metering valve for controlling a rate of reagent injection based on at least one of a combustor load, a fuel flow, a temperature and a NOx signal.

26. The system of claim 19, wherein the valve receives the reagent from the storage chamber at a pressure rate of about 40 psi to about 120 psi.

27. The system of claim 19, further comprising a plurality of injection tips removably securable to the proximal end of the shaft for providing a plurality of reagent spray patterns.

28. The system of claim 19, wherein the atomization chamber receives air from the at least one air port at a pressure rate of about 5 psi to about 40 psi.

29. The system of claim 19, wherein the atomization chamber receives air from the at least one air port at a flow rate of 2 standard cubic feet per minute to 20 standard cubic feet per minute.

30. A system for reducing NOx emissions from a lean burn combustion source having at least three passes, comprising:
a cavity formed between an outlet of a second pass and an entrance to a third pass of the combustion source; and
at least one injection lance positioned in the cavity and comprising:
a hollow elongated shaft with a distal end and a proximal end;
a metering valve positioned at the distal end of the elongated shaft;
an atomization chamber positioned between the metering valve and the distal end of the shaft;
a storage chamber for containing a reagent fluidly connected to the metering valve;
an injection tip positioned at the proximal end of the shaft for delivering the atomized reagent; and
at least one air port for supplying air from an air source to the atomization chamber.
